(19) United States
(12) Patent Application Publication
(10) Pub. No.: US 2009/0307032 A1
(43) Pub. Date: Dec. 10, 2009

(54) BRAND PROTECTION MANAGEMENT SYSTEM

(75) Inventors: Raglan Tribe, Hampshire (GB); Ken MacLauchlan, Hampshire (GB); Stephen Todd, Hampshire (GB); Colin Frey, Hampshire (GB)

Correspondence Address: MOORE & VAN ALLEN PLLC, P.O. BOX 13706, Research Triangle Park, NC, 27709, US

(73) Assignee: ITI SCOTLAND LTD., Glasgow (GB)

(21) Appl. No.: 12/375,197

(22) PCT Filed: Aug. 3, 2007
(86) PCT No.: PCT/GB07/02966

§ 371 Date: Mar. 26, 2009

(30) Foreign Application Priority Data
Aug. 3, 2006 (GB) 0615430.6

(51) Int. Cl. G06Q 10/00; G06N 5/02; G06F 17/30

(52) U.S. Cl. 705/7; 706/52; 705/28; 707/104.1

(57) ABSTRACT

A product management system for monitoring the movement of products through a supply chain, the system being adapted to receive data from reader devices that capture data associated with the products as they move through the chain. The captured data is used to generate an event record for each product, at each stage in the supply chain. These records are used, together with at least one model of the supply chain, to detect anomalous events.

The present invention relates to a product management system and in particular to a brand protection management system for use in industries where there is a need for secure product/part authentication in order to detect unauthorised operations. For example, the pharmaceutical drugs or aircraft parts such as counterfeiting activities, being carried out within the product/parts supply chain.

### BACKGROUND OF THE INVENTION

Supply chains are generally large and complicated with potentially millions of products on the move at any instant. This means that tracking and authenticating products moving through such chains can be complex. Product tracking systems are known for authenticating articles at one or more points in a supply chain. Our pending PCT patent application PCT/GB2007/001248, filed on 5 Apr. 2007, the contents of which are incorporated herein by reference, describes a secure authentication system for use with machine-readable tags. In this system, authentication information relating to items to be authenticated is stored in a database and tag reader instruments are used to read machine-readable tags, such as barcodes, applied to the items to be authenticated. Data extracted from the tags in this way can be compared with data stored in the database so as to determine whether the scanned item is authentic or not.

Included in the system of PCT/GB2007/001248 is a Trust Management System (TMS) for ensuring communications between various physical parts of the system are secure. The system may also include user identification means for authenticating personnel entrusted with carrying out various authentication operations within the supply chain. For example, a user may be required to use a tag reader to scan in a barcode or other machine readable tag attached to, for example, a badge issued to the user. The system may be configured to compare data obtained in this way with user identification information stored in the database so as to determine whether or not the user is an authorised user.

Product authentication systems may generate many event records relating to authentication operations carried out in use of the system, at various stages in the supply chain. However, the generated event records are likely to be incomplete and often noisy as the product moves through the supply chain. Therefore, there is a need for a brand protection management system that can be used in conjunction with product authentication systems to provide sophisticated authentication of articles.

### SUMMARY OF THE INVENTION

In accordance with a first aspect of the invention there is provided a method of detecting unauthorised events occurring in a product supply chain, the method comprising: modelling at least one product supply chain so as to generate at least one supply chain model, preferably comprising a plurality of expected states relating to products; capturing data associated with an item at a plurality of points in a supply chain; generating an event record for the data captured; processing each generated event record, preferably together with other ones of said generated event records, in order to compare said generated event records with at least one said modelled supply chain, so as to automatically detect generated event records which do not match with said modelled supply chain. It will be generally understood that the term “supply chain” as used herein may include manufacturing, distribution and servicing stages. By comparing authentication event data captured from products with a model product supply chain and as they move through the chain, complex inferences can be obtained over time, at different points in the product supply chain. These can then be used to detect anomalies. This authentication can be done entirely independently of the nature of the data capture mechanism, which makes the process truly generic and applicable over multiple industries, even where mass serialisation is required. In addition, the process is wholly scalable and can be used by multiple brand owners at the same time. Furthermore, by monitoring the movement or flow of goods through any given one of the supply chains over a prolonged period of time and comparing the detected pattern of movement with that defined in the supply chain model, it is easier to identify patterns that could be indicative of a threat, as well as individual or one off anomalies. This makes it easier to predict when the next anomaly may occur, so that measures can be taken to avoid it.

The data capturing operation may comprise reading a machine-readable tag (MRT) physically associated with said article/product. The MRT may be a physical tag or label attached to the item or may simply be a visible or covert feature of the item itself, which may be read/scanned/detected.

Advantageously, generated event records relating to a single item in the supply chain are processed so as to compile a representative life history of that item. This has the benefit that it creates product uniqueness even when the products themselves are not marked uniquely because each product will have a unique (life) history.

The processing step may comprise applying one or more pattern matching methods, such as data fusion techniques to match generated event records against one or more of said supply chain models. The pattern matching method(s) may, for example, comprise Markov modelling of event probabilities. Hidden Markov models are ideal for this class of problem where observations can only be made of a side effect of the model, i.e. “the item left the distribution centre and arrived at two destinations”. These observations could imply something irregular has taken place. Other possible modelling techniques include neural networks; nearest neighbour (or k-Nearest Neighbour) and Bayesian networks.

According to a second aspect of the invention there is provided a product management system for monitoring the movement of products through a supply chain, the system being adapted to receive data from reader devices that capture data associated with the products as they move through the chain. The captured data is used to generate an event record for each product, at each stage in the supply chain. These records are used, together with at least one model of the supply chain, to detect anomalous events.

Modelling means may be provided for modelling at least one product supply chain so as to generate at least one supply chain model. An event generator is provided to generate event records from data captured by the data capture means, each event record corresponding to data captured from an item at a point in the supply chain. Processor means process each generated event record, preferably together with other ones of said generated event records, in order to compare said generated event records with at least one supply chain model. In this way, event records that do not match with the modelled supply chain can be automatically detected.

An incident handler may be provided for performing a predetermined action when the processor detects that one or more event records do not match said supply chain model.

The system may include database means for storing the or each the supply chain model. Alternatively, the system may be configured to store the supply chain model(s) in a database means provided in or with the data capture means.

The processor means may comprise mapping means for mapping the generated event records to at least one said supply chain model. The mapping means may comprise Markov modelling means for modelling event probabilities, for example, hidden Markov models and/or other modelling means such as neural networks; nearest neighbour (or k-Nearest Neighbour) and Bayesian networks.

The processor means may include heuristic processing means. Heuristic programming is a branch of artificial intelligence, which uses heuristics—common-sense rules drawn from experience—to solve problems. This is in contrast to algorithmic programming, which is based on mathematically provable procedures. Heuristic programs are self-learning, that is they get better with experience.

The processor means may include sensory processing means configured to synthesize missing and/or additional data from the generated event records.

The processor means may include situation assessment means for continually monitoring the generated event records so as to detect automatically anomalies that may represent potential threats, for example, counterfeit threats. The assessment means may employ forward chaining rules, case based reasoning approaches, or a combination of both.

Preferably, the product management system is configured for communication with the data capture means via a computer network, for example the Internet.

The incident handler may be configured to generate a predetermined response, for example send an email alert message, or a mobile phone text message, to a relevant person or entity, when an anomaly/threat is detected by the processor means.

Alternatively, or additionally, the incident handler may be configured to cause the state of said data capture means to be altered upon detection of an anomaly/threat. For example, the incident handler may be configured to communicate new instrument configurations/settings to one or more instruments forming the data capture means upon detection of a said anomaly/threat. This information could be downloaded in a secure manner via the Internet.

According to another aspect of the invention there is provided an apparatus comprising data capture means for capturing data associated with products in a supply chain, and a product management system according to the second aspect of the invention.

According to yet another aspect of the invention, there is provided a method of detecting unauthorised events occurring in a product supply chain, the method comprising: modelling a product supply chain to provide at least one supply chain model, preferably comprising a plurality of expected states relating to products; monitoring movement of products through the supply chain using data captured from the products at a plurality of points in a supply chain over a period such that multiple passes are made; generating a respective event record for the data captured for each pass of the supply chain and using the event records generated and the supply chain model to detect or predict one or more anomalous patterns.

According to still another aspect of the invention, there is provided a system for detecting unauthorised events occurring in a product supply chain, the system being configured to: model a product supply chain to provide a supply chain model, preferably comprising a plurality of expected states relating to products; monitor movement of products through the supply chain using data captured from the products at a plurality of points in the chain over a period such that multiple passes are made by multiple products; generate a respective event record for the data captured for each pass of the supply chain and use the event records generated and the supply chain model to detect or predict one or more anomalous patterns.

### BRIEF DESCRIPTION OF THE DRAWINGS

Various embodiments of the invention will now be described by way of example only and with reference to the accompanying drawings in which:

FIG. 1 is a schematic diagram of a brand protection management system according to one embodiment of the invention;

FIG. 2 is a schematic diagram of an authentication system that includes the brand protection management system of FIG. 1;

FIG. 3 is a schematic diagram of a brand protection management system according partitioned for multiple brand owners, in accordance with another embodiment of the invention;

FIG. 4 is a schematic diagram illustrating functional software partitioning in the systems of FIGS. 1 and 3;

FIG. 5 is a flow diagram illustrating the operation of an event state machine for use in the systems of FIGS. 1 and 3;

FIG. 6 is a schematic diagram illustrating tracking information for a particular item;

FIG. 7 is a class diagram that illustrates event processing in the systems of FIGS. 1 and 3;

FIG. 8 is a diagram showing a typical inference of a bogus part/item from the inference of an unlikely history trajectory;

FIG. 9 illustrates sequence detection as a technique for detecting fraud;

FIG. 10 is a high level view of the sequence detection of FIG. 9;

FIG. 11 is a first data input from a fraud detection stage into the sequence detector;

FIG. 12 is a plot of offset and gap as a function of values for the data of FIG. 11;

FIG. 13 is a first data input from a fraud detection stage into the sequence detector, and

FIG. 14 is a plot of offset and gap as a function of values for the data of FIG. 11.

### DETAILED DESCRIPTION OF THE DRAWINGS

In Brand Protection applications when a counterfeit is detected it is important to collect as much information as possible, for instance: Where did the counterfeit come from? Is this the first? What is the scale of the problem? Is there enough information to launch a successful prosecution on the perpetrators? In logistics applications, it is also useful to know at any instance: Where are all my parts? What configuration are they in? Where are they going? Are they suitable for that market? In some applications the act of authentication relies on matching a unique serial number on the product to a serial number stored in a database, if there is a duplicate then one of the items in question is a counterfeit. The issues with this are then: Is this the original or the counterfeit? Is it the same product that has just been authenticated twice in the supply chain or are there duplicates? Are there duplicates or many more?

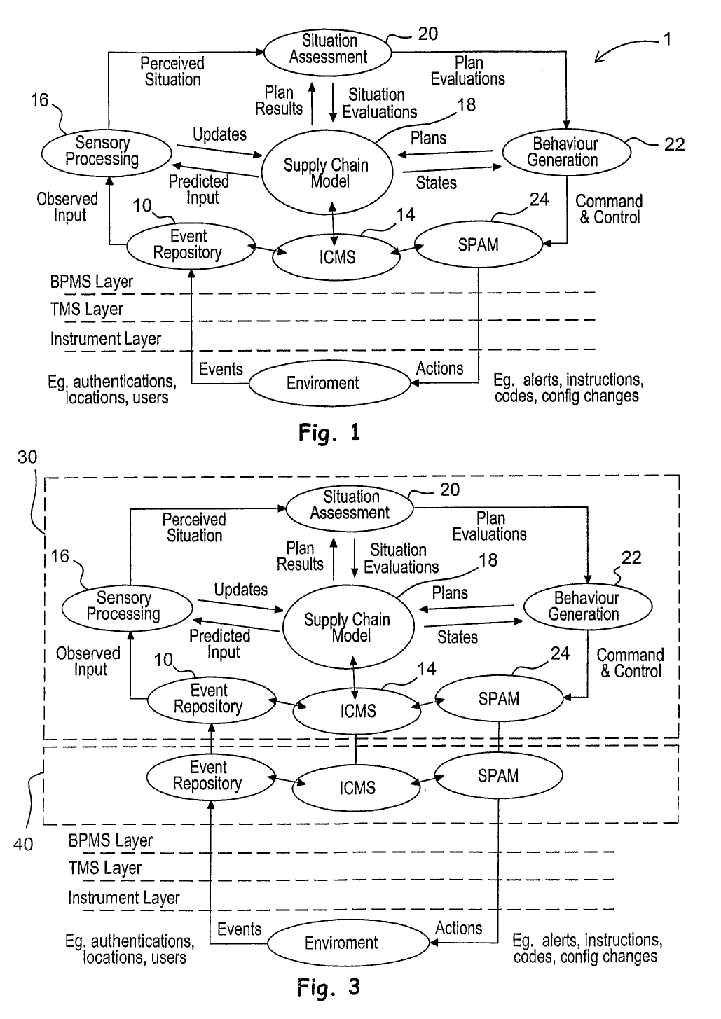

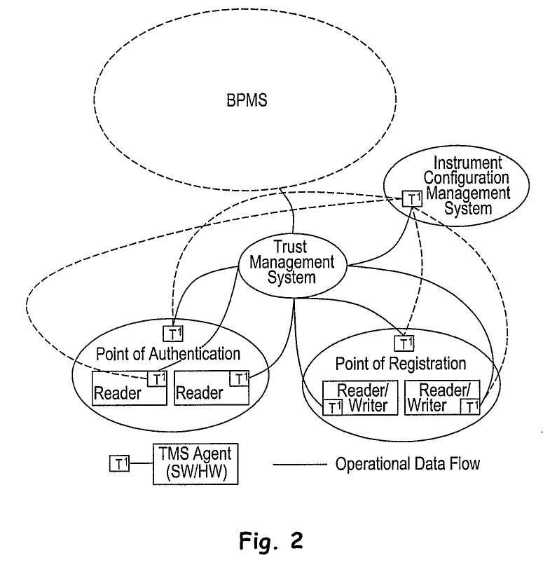

FIG. 1 shows a brand protection management system (BPMS) 1. In practice this is used in conjunction with a product authentication system, such as that shown in FIG. 2 and described in PCT/GB2007/001248. The system of FIG. 2 has Point of Registration (PoR) systems and Point of Authentication (PoA) systems provided at various locations in a product supply chain. In a typical supply chain, a very large number of PoAs and PoRs are likely to be associated with the BPMS, possibly spread over a number of different countries. However, all of them can communicate with the BPMS of FIG. 1 via a central Trust Management System (TMS) using whatever standard communication method is most appropriate, e.g. TCP/IP over LAN for fixed devices or WiFi for portable devices or GSM etc.

Each PoA/PoR system contains a reader instrument, local networking capability, and in some cases may also include a security printer instrument and/or a local Personal Computer (PC). The reader instruments comprise brand protection feature (BPF) reader devices, for example barcode scanning devices, for reading BPFs on articles to be tracked/authenticated. Each PoA/PoR may also include a printing instrument to generate BPFs, for example labels, as well as read them. Each PoR may be capable of generating BPFs to be applied to new (i.e. not previously tracked) articles, at a start or registration point in the BPMS scheme. In addition, user authentication devices may be provided, for example, SMART card readers, for reading identification information provided by a user for authentication purposes.

The BPMS of FIG. 1 has a number of functional parts, including an event repository 10, an instrument model (ICMS) 14, a system policy administration manager (SPAM) 24 and a supply chain model 18, which has knowledge of the supply chain and a simulation capability that enables the generation of expectations and future states. The supply chain model 18 is adapted to receive inputs from and provide outputs to various functional components, including a sensory processing function 16, situation assessment function 20 and behaviour generation function 22. The event repository 10 assembles multiple events into a coherent image of the environment according to the known PoA/PoR instrument model. The instrument model (ICMS) 14 contains known configurations, locations, users, and modalities of the instruments, and enables the configuration of the instruments to be managed by setting instrument policies. The ICMS policies are managed by the SPAM 24. Incorporated in the SPAM 24 is an instruction assembly, which assembles instructions into the correct format according to the instrument model.

Brand protection systems will often be used by more than one brand owner and potentially by other organisations such as regulators. Each of these organisations may run their own brand protection system 30. Some aspects of the brand protection system will however have to be shared, for example to enable two brand owners to share the same PoR system at a manufacturing site or for a brand owner's information also to be shared with a regulator. The shared parts 40 of the system provide a complete picture of the instruments in the field (while the brand owner's knowledge pertains only to his use of the instruments) and ensures that authentication events and instructions are routed to/from the brand owner's/regulator's brand protection system. This is illustrated in FIG. 3, which shows that parts of the event repository 10, the ICMS 14, and the SPAM 24 are shared, and other parts are not. This partitioning of shared 40 and organisation specific 30 BPMS sub-systems is reflected in the specification of the event repository 10, ICMS 14 and SPAM 24.

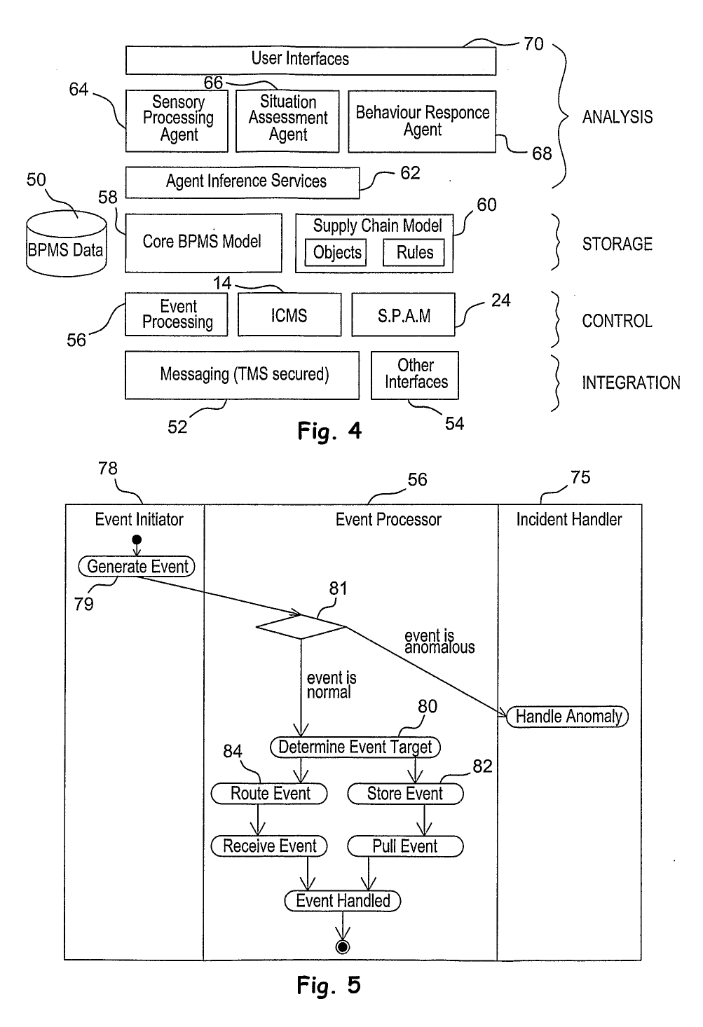

FIG. 4 shows how the functions shown in FIG. 3 map onto a software architecture. In this case the architecture has four main layers, these being an analysis layer; a storage layer; a control layer and an integration layer. The analysis layer includes user interfaces 70. The user interface is a “real time” user interface that includes dashboard-like functionality, connectivity with geographical information systems, such as Google Maps, and 2-D interactive graphics to provide easy human visualisation of item tracks and anomalies. It could include reports from database reporting tools, allowing tabular online analytical processing (OLAP). Also included in the analysis layer is a plurality of agent modules for implementing the various functional components 16, 20, 22 of the BPMS of FIG. 1, including a sensory processing agent 64, a situation assessment agent 66, a behaviour response agent 68 and an inference services agent 62. These will be described in more detail later. The storage layer includes a database 50 for storing persistent data; the core BPMS model 58 and the supply chain model 60. The control layer includes an event-processing module 56 for parsing and construction of messages for transmission to, for example, the TMS, and any other interface or system management functionality outside the BPMS. Also included in the control layer are the ICMS 14 and the SPAM 24. The SPAM 24 defines the items that are being managed by the BPMS, and the brand protection policies that can be applied to them. Using these definitions, the ICMS 14 and behaviour response agent 68 can change the state of instruments for an individual brand, by for example downloading new or up-dated policies to them via the TMS, and so define how the system should react to anomalies that might be detected in the normal course of events, or put the instrument and system in some higher level of activity status should the situation assessment/behaviour generation have detected a situation that results in a different and higher status being warranted. Below the control layer is the integration layer. This includes some general interfaces to allow, for example, e-mail alerts to non-trusted hosts, and messaging facilities for allowing data transmission secured by the TMS, for example BPF event data from the reader instruments at the PoRs and PoAs. Messaging may be based on a variety of possible technical solutions including COTS XML based messaging systems, with the security functionality added by the TMS.

Each PoA/PoR reader instrument is loaded with brand protection instrument activity policies, as set by the ICMS 14. The instrument policies define the items that the instrument is able to authenticate and how to authenticate them. For example, each instrument activity policy may have three brand protection instrument activities that are definitions of the activities to be performed in different instrument states. These three activities may define how to authenticate in the default mode, how to authenticate where an initial part of a scanned code determines how to interpret the rest of the code (2 part scan), and how to authenticate when the type of item is first identified visually by the inspector, so a certain type of item is expected. Each instrument policy may be associated with a particular brand, and may identify the organisation the policy is associated with, and their hierarchy. When the hierarchy of all organisations using activities policies on the instrument is known, the instrument can use the hierarchy to pick the policy used by the highest-ranking organisation as its default or where there is a conflict of interest. Preferably, the hierarchy of each policy is also known, so that if more than one policy is known for an item, a different policy of a higher or lower ranking can be activated as required.

Not all activities policies need to be held on the BPF reader. Some can be held at another location accessible by the PoA/PoR readers and loaded as required. Policies may be associated only with instruments of a particular type. Some policies may only be relevant with the context of a particular PoA system. These policies may identify which instrument activities can be loaded onto the instruments. Each activity policy must be associated with the appropriate item type and brand-owner id for that policy. Typically, there is a default mode when no brands/items are selected. The brand protection instrument activities define all the aspects to do with the read/scan, such as what algorithms should be used, what script can be used, etc. Since the steps taken to verify a code could be highly complex, these are controlled by the associated activity policy and may involve the display of instructions on the instrument to the user. For example, the instructions might involve first scanning part of the code, and a next step to retrieve further instructions from the PoA or the BPMS. These instructions may in turn lead to further steps requiring instrument interaction with other parts of the system.

Using an instrument to scan an item generates a brand protection feature event. Each BPF event records basic information about the identity of items and containers progressing through the supply chain. Ancillary information objects are used to record industry specific data. For example, aerospace companies may want to store information that currently accompanies shipments of aircraft parts in paper form. This may include information about the origin of parts as well as their repair and service history. Pharmaceuticals companies may want to store a completely different set of information along with each event. Therefore, there will be different classes of ancillary information according to the industry and possibly the individual brand owner.

Each BPF event is captured at the PoAs and PoRs and notified to the core BPMS model 58, which includes an event model. The event model has to be able to capture event types and handle ancillary information associated with an authentication event such as a complete repair record for an aircraft part, and ensure that this is stored in the BPMS data store 50. It also has to be able to restrict access to an organisation or group of organisations (owned or shared); record an arbitrary identifier for an item that can act as a key into other BPMS information; include legacy, non-TMS enabled instruments in the system; handle different types of authentication “scripts” defining how the authentication should be done; link together information to form a single audit activity; and relate items and events to the organisations which either own the data, or which require partial shared views of the event data. In this context, owner organisations will include brand owners. Organisations requiring shared organisation views may include regulators or other cross-industry organisations. The event model also has to be able to capture the details of the entities that initiate events including brand owners, points of registration, points of authentication, and repackaging sites (e.g. sites that split or join bags or repackage an item). Brand owner related information specific to the brand owner concerning information routing, code generation, etc, is stored by the event model. Most of the events that have to be modelled will be verified as a true event by the TMS. However, the flexibility of the typology allows informal, less well-verified information to be captured, if required.

FIG. 5 shows a high-level diagram illustrating some key features of event processing. These functions are implemented by an event initiator(s) 78, the event processor 56 and an incident handler 75. The event initiators 78 generate BPF authentication events and ancillary information instances. An instrument scan, printing a security code or updating the system initiates an event. All events are generated as a result of a security policy associated with the instrument, as defined by the ICMS, and an action in the real world that is covered by the security policy. The event initiator 78 communicates with the event processor 56, which routes events to the appropriate target such as a brand owner and other nominated receivers as defined by the SPAM 24. It also purges event information from the central repository 10 according to the policy defined by organisations that own the events; checks the validity of codes related to events; pulls events from an event provider and transmits events from instruments that are on-line in close to real time, typically within 10 seconds. Events from instruments that are off-line may occur at irregular intervals by batch transmission, for example probably once per shift, i.e. every 8 hours, when a scanning instrument has to be docked with a PoA/PoR instrument. If the event processor 56 determines that an event is anomalous, a message is sent to the incident handler 75, which records all incidents and knows what action to take in the event of an incident, for example, immediately notifying the brand owner and/or deactivating the instrument where the incident occurred.

Typically, the event initiator 78 is physically running on a source machine at a PoR or PoA. An event is generated 79, for example, by an instrument scan or a security print etc. The event processor 56 then decides 81 if that event is a normal event or an anomalous event. If the event is anomalous, a message is passed to the incident handler 75, where it is marked appropriately and automatically routed to the appropriate target. This enables simultaneous routing to the brand owner and to a second organisation. If the event is normal, a message is routed to the determined event target function 80, which uses the data in the SPAM 24 to identify one or more recipients of the message. Depending on the target once an event message is created, it is either stored 82 as a BPF event record in the event repository or immediately broadcast by the route event task 84.

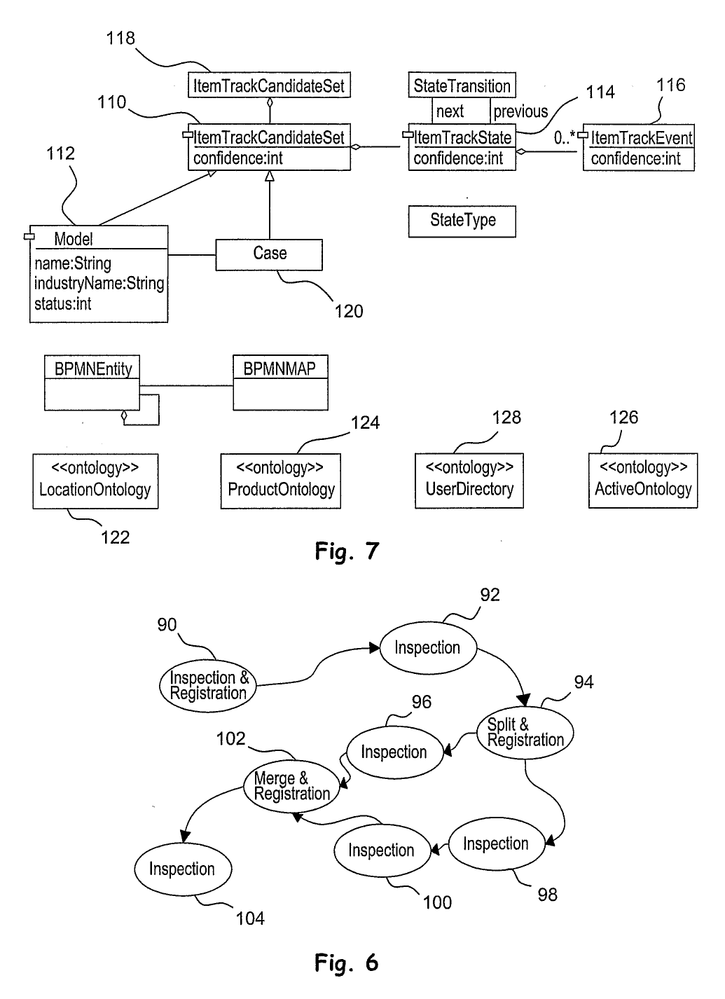

FIG. 6 shows an example of high-level track formation for a particular item that has a typical supply chain life history. The history starts when the item is first inspected, scanned and registered 90. A further inspection and scan 92 is carried out at a later stage in the supply chain. The item is then split into two (e.g. the item may be a pallet of products which is split into two parts) and the split portions are registered 94. Each portion is then inspected again 96,98 at a later stage in the supply chain. One portion has a further inspection 100 carried out on it. The two portions are then merged again and the merged item is registered 102. A final inspection 104 is then carried out at a later stage in the supply chain. Each of these events is captured and stored in the BPMS data store for later analysis.

BPF event data for an item is stored as it moves through the supply chain, as part of an item track. This tracks the successive lifecycle states of the item or container in question as it moves through an instance of a supply chain. In practice, this is not intended to suggest a perfect situation where a complete item track can be created to act as an audit trail for the whole lifecycle of an item, as there are likely to be missing links in this trail. Event typologies allow the capturing of changes that are relevant to authentications. The relationship of products (items) to the containment hierarchy is saved as a history. For example, an item may be packaged, sealed with a tamper proof seal and then have a code registered. It may then be placed in a carton on a pallet which is later split into units which then have codes registered at the carton or pallet level. The model allows for the management of these different code and item containment relationships over time.

Using the supply chain model, the event data in each item track can be compared with the a priori knowledge of the supply chain and rules or policies that are created by the brand owner. Each supply chain model defines the expected graph of locations, organisations and users involved; static ontologies that add detail to the BPMS data about locations, activities, products, users and organisations; location ontologies that include data sets for drawing inferences about the movement of shipments; generic rules about supply chains and the connectivity between nodes in item track graphs for matching the partial data in the BPMS event model and industry and brand-owner specific rules about supply chains.

FIG. 7 shows a high level design of the supply chain model. The item track 110 is core to this and represents the life history of a single item. This may often be partial, because certain states in a particular instance of a supply chain lifecycle may not have been recorded, or data may be missing or unavailable at any particular time. The states of the item track may be predicted or model states, observed or inferred in type. When the item track is composed only of model states, it is referred to as a supply chain model. When the item track is composed only of observed events, this is referred to as a normal track and may be unlikely to occur in many cases. When the item track is composed of observed and inferred states, this is referred to as a “Candidate Model” and may partially match a number of supply chain models. The item track 110 may contain sub graphs that are not completely connected. It may also contain a complete graph, but may have low confidence rankings for parts of that graph. States and events that are inferred may have low or high confidence ranks associated with them.

Associated with the item track is a model 112, which is composed only of model states and an item track state 114, which is a single state in the lifecycle of an item. These states should match instances of a particular supply chain lifecycle. Failure to match such a state may indicate an anomaly or may simply result from poor data quality. Possible lifecycle states are determined by the supply chain model. Modelled or expected states represent states that are expected as part of a specific modelled supply chain. An observed state is one where the properties of incoming events can unambiguously match a model state. This matching is performed through conventional data driven forward chaining rules executed by the sensory processing agent. An inferred state is one where the probability is high that the state exists. This is determined by taking each candidate item track and using an appropriate inference approach either HMM or constraint propagation to find the matching models, i.e. model item tracks.

An item track event 116 is an event associated with a state 114. Generally these will be BPF authentication events, but other events may be useful in defining anomalous states. Irregular events are detected from the application of the supply chain rules and marked as threats in a situation assessment class—this will be described in more detail later. Any set of actual input data may give rise to a number of candidate item tracks. Therefore, there needs to be a means of associating related item tracks. This is the function of the item track candidate set 118. A case 120 is an item track that represents an anomalous item track that needs to be kept for future use in identifying possible problems. Cases 120 contain case notes that provide documentation of the experience. Each case is associated with one or more supply chain models. Ideally, it is associated with only one when it is closed. However, it is possible that a case is associated with more than one when it is not closed. Over time, cases accumulate and may be used to improve the accuracy of recording transition probabilities or in the detection of anomalies via case based matching to new item tracks.

As mentioned previously, the supply chain model has various ontologies. These include: a location ontology 122, a product ontology 124, a user directory ontology 128 and an activity ontology 126. The location ontology 122 contains domain/real world information about locations combined with rules and algorithms for location related inferences, e.g. calculating distances. The product ontology 124 contains a detailed knowledgebase about the products that are tracked as items in the system. The user directory ontology 128 is a directory of organisations, users roles and associated data. This is effectively a superset of the information required for the SPAM 24. This additional information is not required for day-to-day operation of systems, but may provide useful information for analytic and inference agent processing. The activity ontology 126 contains a knowledge base about what activities are possible, and knowledge rules, which express domain relationships.

The supply chain model 60 and the event model in the core BPMS are used by the analysis agents 62, 64, 66, 68 to identify anomalies in the movement of products through the supply chain of FIG. 4. The agents 64, 66, 68 combine conventional object oriented procedural operation with calls to the agent inference service layer 62, which enables the execution of supply chain model rules. In addition to the rules present in the supply chain model, each agent has its own supplementary rules. For example, the supply chain model has a set of basic rules about the connectivity of networks while the sensory processing agent 64 has its own pattern matching rules, which help with the completion of partial information.

The agent inference service 62 includes a pattern matching and inference processor capable of executing the processes and rules required by the other agents, as well as an efficient mechanism for pattern based reasoning and graph traversal and sub-tree matching. It also provides an interface between the inference processing agents and the core BPMS model 58. The agent inference services 62 have the ability to reason backwards and forwards from data to results and also from a goal to a solution. Logic programming systems are a flexible way to achieve this capability and are available in forms, which are able to reason over models defined as objects. Matching partial item event tracks to supply chain models is a typical use of inference systems that have built-in search capabilities.

The agent inference services 62 use heuristics defined for particular supply chains as part of a specific supply chain model. To summarise the features of the inference services 62, they are able to: naturally represent directed graphs; integrate graph search and matching with heuristic processing; provide pattern matching capabilities through hidden Markov modelling (HMM) of event probabilities; work with poorly defined and dirty data input (HMM), including data such as isolated false PoA events; use technology which can be flexibly integrated with object based languages such as Java and the J2EE platform; allow rules to use object data from the BPMS object model and the supply chain model as values, which can be interrogated and matched by predicates and allow compilation of frequently executed rule sets into Java code for more efficient execution. Alternatively the services could offer the ability to provide compiled rule sets as a remote object, which acts as a wrapper, capable of being called from the final implementation architecture.

The sensory processing agent 64 puts together all of the events for a particular item to create a track for its life through the supply chain. The track formation is often complicated because some items are split and some merged, for example in batches. In addition, sometimes the authentication events may be omitted and counterfeit items may skew the track integrity. To deal with this, the sensory processing agent 64 is operable to use rule-based inference to suggest connections between partial events. Algorithms integrate similarities and differences over time to generate a robust prediction of the world. The sensory agent 64 uses generic inference rules for piecing together the available track data as sub trees of a graph with appropriate splits and merges. These sub trees can be matched to the data and rules in the supply chain model to suggest both: (a) The likely normal track which should have taken place and (b) Potential anomalies in the life cycle of items moving through the supply chain. Furthermore, supply chain rules are required to correctly link the events, to augment the track with missing pieces of information and to separate counterfeits from noisy but genuine authentication events. The supply chain rules can also include item ordering, dispatch or shipping information to further augment the inference of the most likely track.

To synthesize incomplete and possibly inaccurate data into candidate sequences of information that match supply chains modelled in the supply chain model, the sensory processing agent 64 uses one or more of the following kinds of processes: constraint based search through an acyclic directed graph to infer how events map onto supply chains; domain specific rules which enable the completion of partial information using the ontologies available in the supply chain model, and reasoning about sequences of events using an event calculus. In a preferred embodiment a constraint-based search is used, coupled with domain specific rules, which format and add information to event data. Event calculus may not be a requirement as event based reasoning may only need to be quite simplistic. It may be acceptable to introduce a small set of event related rules for this purpose.

The situation assessment agent 66 uses features identified during sensory processing to form mappings to the supply chain model 60 or to identify anomalies or mismatches, thereby to identify potential threats and make a value judgement based on the observed states of the world. By threat, it is meant a possible threat to the Brand integrity through the supply chain. Threats may relate to a variety of entities in the system and are associated with a severity, a description and an a priori likelihood of occurring. This may alter over time as experience indicates the frequency of threats. A threat with very high severity may be important even if its likelihood is low. Some threats will be straightforward irregularities with a track. However, in other cases the threat identification may result from very minor irregularities across many tracks.

The situation assessment agent 66 is operable to predict results of hypothesised plans in order to compute costs, risks and benefits of observed situations and planned activities. The situation assessment rules are developed by brand protection operators and automatically applied across the tracks to detect these threats. Each threat has a description as well as a likelihood and severity attributes to aid the prioritisation of threats. The situation assessment agent 66 uses one of the following approaches to identify possible threats and situations, which may apply for a specific item track: forward chaining rules (RETE algorithm) and/or case based reasoning approaches. For item tracks that have been detected as being in some way anomalous, a situation assessment is generated. The anomaly is defined by the threat associated with the situation assessment, which is attached to the case related to the item track in question. The situation assessment contains an inference history, which allows the reasons for the assessment to be identified. Actual conclusions of the situation assessment are stored as notes in an associated case. These notes are marked as having been inferred rather than added by a human user.

The behaviour generation agent 68 develops the appropriate response to suspicious or anomalous events or even sequences as determined by the situation assessment agent 66. This may be via communications with human users or through dynamic communication with other information systems within and without trust boundaries. These responses are then sent to the field via instruments, e-mail alerts or text messages. For example, the response may be to change the state of one or more of the instruments e.g. by downloading in a secure manner via the Internet. New instrument configurations/settings/policies may be communicated to one or more of the instruments, upon detection of an anomaly/threat. Behaviour generation rules configured by BPMS operators generate the field instructions in response to each threat. Another consideration is that instructions are assembled over a considerable period of time as many of the instruments may not be online (with the BPMS) and so the programs cannot be executed until they are downloaded to the instrument. Therefore, queued instructions must be monitored in the light of new instructions to remove contradictions and ambiguities.

The behaviour generation agent 68 operates on situation assessments that represent candidate item tracks that have been detected as being in some way anomalous. The anomaly is defined by the threat associated with the situation assessment, which is attached to the case related to a candidate item track. The behaviour generation agent assesses behavioural goals and works with a small well-defined set of situation assessment(s). Because of this, a backward chaining algorithm is appropriate for its operation. The behaviour generation rules are an instance of a rule set. This allows the identification or construction of an appropriate behaviour script. The behaviour script instance determined by these rules is executed by the behaviour generation agent 68 and a record is kept via the association between the case and the behaviour script. This provides an audit trail of the behaviour that resulted from the identification of a case.

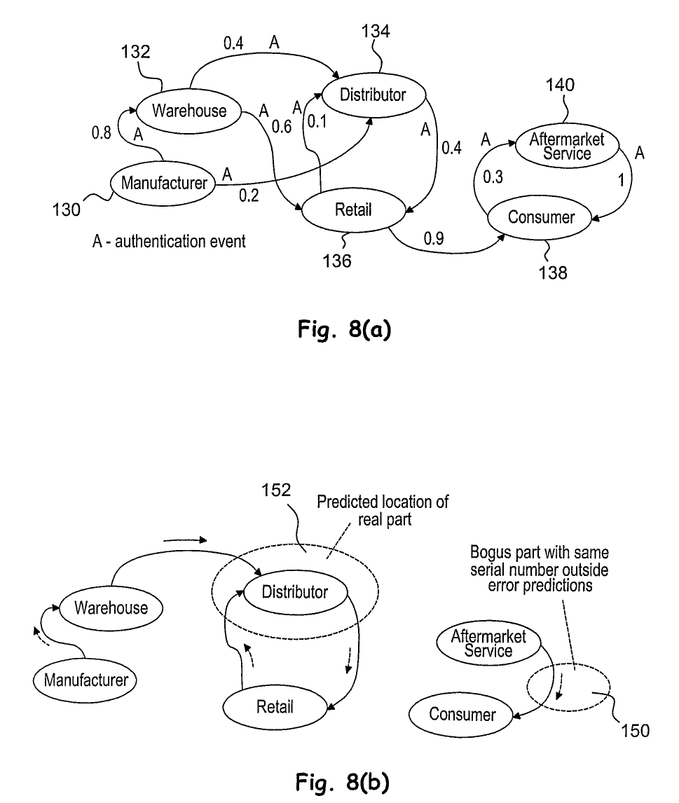

Supply chains are often extensive and complicated, and there could be millions of product items on the move at any instant. Using a priori statistical models improves the signal to noise ratio of the captured history and allows products to be authenticated or identified as anomalous. Counterfeits are detected because they are likely to be outside the predicted error parameters of the movement of the genuine product. This allows genuine items and duplicates that are moving through the supply chain in an unlikely way to be distinguished. FIGS. 8(a) and (b) show a typical inference of a bogus part from the inference of an unlikely history trajectory. FIG. 8(a) shows a statistical model of likely trajectories and the authentication events A, which have been generated/carried out at various stages in the supply chain, as the product moves between the manufacturer 130, warehouse 132, distributor 134, retail 136, consumer 138 and aftermarket service 140. FIG. 8(b) shows the detection 150 by the BPMS system 1 of an impossible location for the genuine article, the predicted location 152 of the genuine part being somewhere else in the supply chain model. From this it can be inferred that the part is bogus.

By monitoring all goods that move through the supply chain there is provided a method of detecting unauthorised events occurring in a product supply chain. The invention can also be used to predict future events. This can be done by monitoring movement of products through the supply chain over a period in which multiple passes of the supply chain are made and generating an event record for the data captured for each pass of the supply chain. These event records can then be used predict one or more anomalous patterns. In one embodiment, events are classified as genuine or fraudulent activities, summarised by date and fed into a fraud prediction and sequence detection module for predicting the next occurrence of fraud.

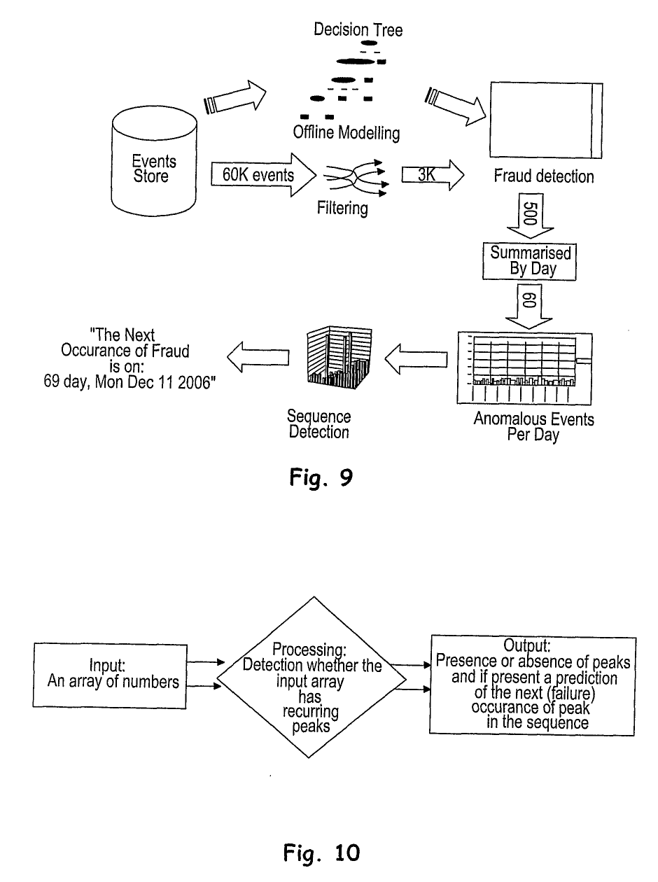

FIG. 9 shows sequence detection in the context of the overall BPMS functionality. This uses the data in the events database to identify potentially fraudulent activity, as described above. Data on events that are identified as being anomalous or fraudulent is summarised by day and this daily data used to establish whether there are any repeating sequences that could be used to predict future events. The input to the sequence detection module is an array of numbers indicative of anomalous events and the output is a prediction of the next future occurrence of peak in the sequence, as shown in FIG. 10.

The sequence detector works by producing a frequency and phase map of the input dataset. The map is generated by running through every phase and frequency possible within the original dataset and calculating the average value seen for each. Points in the map with a high average value will have seen a high number of occurrences of suspicious events and are candidates for being a fraudulent sequence. To separate the points of interest in the map from the background noise a threshold is set at n standard deviations above the average within the map where n is normally two or three. Higher factors of the sequence of interest are eliminated. For example, if a sequence repeats every seven days, two sequences highlighted with fourteen day gaps and a seven day phase difference between them will also be seen. To avoid this distorting the analysis, these higher factors of a peak of interest are removed, even if they have a higher value within the map. Once a sequence of interest is detected it is extrapolated beyond the end of the dataset to produce a prediction of the most likely next occurrence. If there is no recurring pattern in the input array, no sequence is detected and no prediction is made.

The following is a more detailed description of the processing stage of the sequence detector: First the data length is set to be equal to the length of the input array. Then a sequence spacing vector is generated according to 1<Sequence Spacing<(Data Length/3). The sequence spacing is the inverse of the frequency and represents the distance between peaks in the input data. The range of sequence spaces to be searched is bounded by a minimum of 2, as there must be a gap of at least 1 between peaks to have a valid sequence, and a maximum of the length of the input data array divided by 3 to ensure that even for the longest sequence gap looked for at least 3 peaks will be seen. An offset vector is then generated according to: 0<=Offset<Sequence Spacing. This offset is the phase represented as the start position of the sequence within the input array. For each valid sequence spacing a matrix is generated for each of the valid range of offsets. This results in a triangular table. The values entered in the matrix represent the mean value seen in the original data for the current frequency and phase.

Once the matrix is generated, the mean and standard deviation of the data in it is calculated and a threshold set at (mean+n*standard deviation) where n is typically 2 or 3. This gives a dynamic threshold that responds to noise in the matrix and highlights peaks within it that are statistically significant. From peaks in the matrix above the threshold those that are a higher factor of another peak of interest are eliminated. This results in the Sequence Spacing and Offset (or phase and frequency) of sequences with statistically abnormally high mean values in the original dataset. Then the number of the last peak seen in the original data sequence is calculated as x, where x=(Data length−Final offset−1)/Final Sequence Spacing. Predictions of future likely dates of fraud are calculated by iterating x beyond the end of the data and calculating the resultant date.

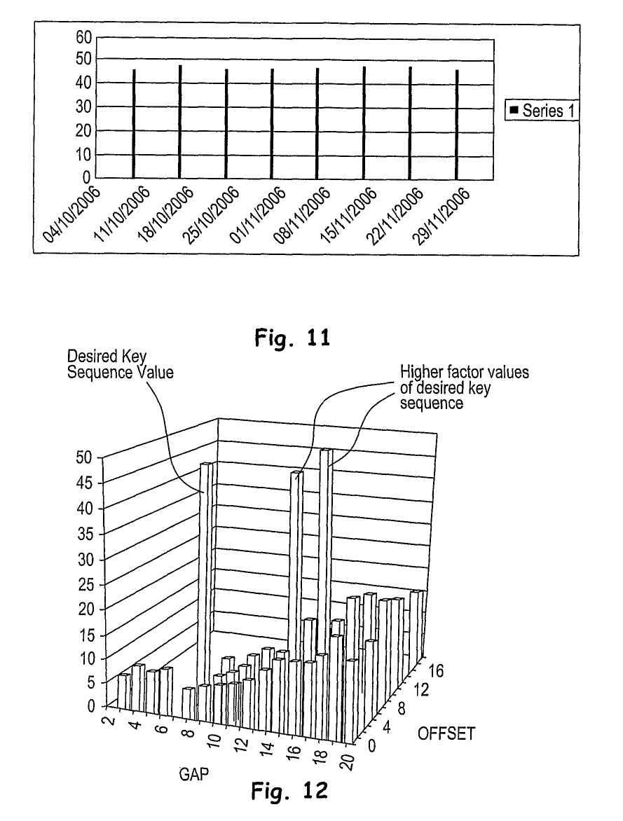

FIG. 11 shows an output array from the fraud detection stage for a first data set. This is input into the sequence detector. The matrix generated from this data is shown FIG. 12. The occurrence of peaks gives an indication of presence of regular repeating fraud patterns. After the threshold is applied, only the highest peaks are chosen and then higher factors are eliminated. In this case, the value of interest occurs at a sequence spacing value of 7 with an offset of 6. The next predicted occurrence of fraud is at: day 69, Mon Dec. 11, 2006.

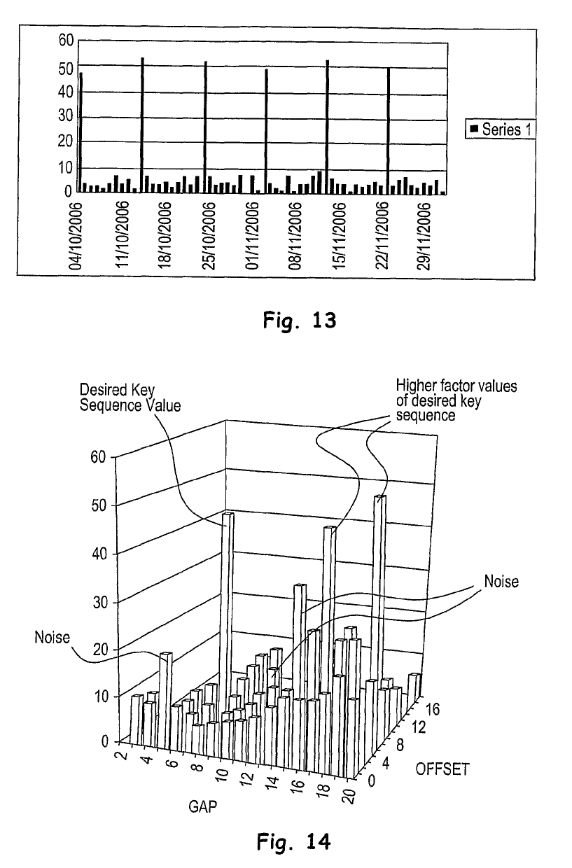

FIG. 13 shows the input array from the fraud detection stage into the sequence detector for a second data set. The matrix generated from this data is shown in FIG. 14. The occurrence of peaks gives an indication of presence of regular repeating fraud patterns. The matrix is thresholded to select the highest peaks and once the higher factors are eliminated only the peak with a sequence spacing of 10 remains. In this case, the next predicted occurrence of fraud is at day 61, Sunday, Dec. 3, 2007.

Using sequence detection in accordance with the invention provides a reliable, robust and scalable technique for predicting future fraudulent events. This is advantageous, particularly in large complex supply chains where significant numbers of goods are flowing through the system.

Ideally, the BPMS system in which the invention is embodied is run continuously so that event information for products moving through each supply chain is regularly being fed into the system for analysis. Because the event data for any given supply chain is continually recorded, it becomes easy to detect patterns of fraud, as well as individual or one off threats or anomalies. For example, it is possible that at one location on the supply chain there is a person who is stealing products. By monitoring the pattern of the theft over a prolonged period of time, it is easier to identify the perpetrator, because the theft may, for example only happen when they are responsible for a particular part of the chain. This means that the next attempted theft can be predicted with reasonable accuracy and measures taken to avoid it.

In the BPMS, the item can take various forms. For example, it may represent an individual indivisible final unit of product, i.e. the “atomic” and smallest possible unit that in theory could be scanned. Alternatively, it could be many products packed into a series of containers or levels of packaging. For example, in the pharmaceutical supply chain a single pill might be packed into a blister, which is then inside a package, which in turn is within a larger carton which is then bundled onto a pallet to be shipped inside a shipping container. Scanning, and event generation can be carried out at a variety of levels within this component hierarchy. Containers can have subclasses that have special significance or meaning to different supply chains. This is shown by the batch subclass of container. Batches are a special case where the container is a conceptual aggregation of items, rather than a physical container. An item can simultaneously reside on a pallet while belonging to a batch. Two items on the same pallet may have originated from different batches. By ensuring that the appropriate hierarchy is modelled, both variations can be captured.

The system of the invention may be used in numerous applications. For example, pharmaceutical companies could use it to trace packets or pallets of drugs. It may equally be of use to aircraft manufacturers and airline operators to keep track of genuine aircraft parts. Other applications are also possible, for example in tracking/managing branded consumer goods such as whisky, perfume, designer clothing etc. Because of the flexible nature of the system and the fact that it is not limited to the use of a particular tag, its potential applicability is extensive.

Another area where the invention has potential uses is in monitoring the dispensing of drugs with the potential to identify unusual patterns of activity. Dispensing errors cause problems in the UK, with the National Patient Safety Agency reporting 40,000 errors in 2006, with 2000 proven to have caused harm to patients. The UK Dispensing Error Analysis Scheme reports that 33% of medication errors are linked to look alike/sound alike drug names, 23% to high workload or low staffing and 14% to transcription errors. In UK hospitals and pharmacies, pharmacists, nurses and doctors perform most dispensing manually. This introduces a real possibility of dispensing errors, due to overworked staff being expected to perform many critical tasks in very close succession.

In accordance with the invention, a policy can be created for use on a hand held instrument at a hospital pharmacy, a commercial pharmacy or the patient's bedside to ensure that dispensing errors are reduced to the minimum possible level. The policy is structured to ensure that anyone using the workflow on the instrument is forced to comply with the standing operational procedures in force at the time. By downloading up-dates as and when necessary, the policy can be easily modified to reflect changes in procedure. In accordance with the invention, retention of a history of all the captured events in the workflow and the user's compliance or non-compliance with the workflow provides an audit trail for later use in investigations if necessary.

As part of the workflow, cross-checking with an electronic formulary and with patient records could be done, including information about previous adverse reactions and allergies, and the interaction of the proposed drug with any other medication that the patient is known to take. This cross checking could happen automatically. Failing that, the policy could be written to instruct the dispenser to check the patient records and the formulary, either manually or electronically. If the dispenser failed to acknowledge that these checks had taken place, the policy would terminate the workflow and an adverse incident would be logged. The audit trail would quickly lead the investigator to the time, place and dispenser. By monitoring recorded events over a period of time and using the predictive analysis of the invention, dispensing errors may be predicted.

The policy guides the dispenser along a workflow that ensures compliance with pharmacy or hospital dispensing procedure and allows cross checking of the prescription with the dosage and product listed on the pack. The most important elements of the prescription are patient name, drug name, dosage and unit of dosage. Information could be entered into the instrument in a variety of ways. For example, the prescription could be downloaded electronically or a barcode could be scanned from a pre-printed prescription. Other options include optical character recognition on a printed, typed or hand written prescription. Alternatively, details of patient, drug and dosage could be manually typed into the instrument.

If the platform has been integrated with the pharmacy or hospital computer system, it would be possible to automatically check the drug and dosage that have been picked from the shelf before they are dispensed. This is usually done manually by a pharmacist, and is known as the “professional check”. Pharmacists, however, have many demands on their time, and if they are interrupted during a professional check, may miss a crucial fact, which could potentially lead to a dispensing error. The guidance of the policy would help to ensure that the correct drug and dosage were picked from the shelf, and all the professional checks were completed. The retention of the information on the instrument and its subsequent transmission to and storage on the back end server would provide an audit trail. In a pharmacy, the instrument could be integrated with the point of sale to trigger a request for payment once dispensing is complete.

Another useful application is at the end of the dispensing cycle, when medicines are dispensed to patients on a hospital ward. Nurses with limited pharmacological knowledge and many conflicting time demands normally do this. On a busy medical ward, each drug round can take up to one hour and demands the full-time attention of two nurses. With this system, only one nurse would be needed to do the drug round, releasing one nurse for other aspects of patient care. The nurse would log on to the instrument with a user ID and a ward ID. This then establishes who dispensed the drug, where and when. Each patient's drug chart and wristband would have a unique bar code, and these would be scanned with a hand held instrument. At this point the relationship between patient, nurse, ward and drug chart is established and the event is electronically recorded. The nurse would then be directed by the workflow to pick the drug from the trolley and to scan the pack. The system displays the drug and dosage and records the event electronically. The nurse would then give the drug to the patient and press a button on the instrument to record the administration of the drug. There would be an option to record if the patient refused the drug, as it is vital to record whether the patient actually took the drug, because this can be as harmful to the patient as getting the wrong one. When the nurse completes the drug round, she would log out and the entire history would be transferred to the server. This would create an audit trail that would be readily accessible if necessary, thereby to provide a full history authentication.

If the system were fully integrated with patient records and pharmacy systems a reduction in dispensing errors could be achieved, as a handheld instrument would confirm that the correct drug and dosage are being picked from the shelf, as these would be scanned as part of the workflow, with incorrect drugs and dosages generating a bad scan. Drugs and dosages administered to patients would be much more accurately recorded. A full audit trail would aid investigation of errors. Predictive analysis may enable prediction of future errors based on pattern and trend analysis.

Another potential application would be repackaging combinations of drugs for dispensing to individuals, for instance in a nursing home. A policy could be written that would require the user to certify that they were competent to perform the task, that the environment was correct, and to scan each drug, both to maintain the relationship between the original label and the new label, and to check that the drug was correct in name, dosage and unit.

The present invention can be extended to support a drug pedigree. As described by the US Food and Drug Administration (FDA), a drug pedigree is a statement of origin that identifies each prior sale, purchase, or trade of a drug, including the date of each of those transactions and the names and addresses of all parties to those transactions. Under the Prescription Drug Marketing Act of 1987 (PDMA), each person who is engaged in the wholesale distribution of a prescription drug in interstate commerce—who is not the manufacturer or an authorized distributor of record for that drug—must fulfil the requirement by providing to the person who receives the drug a “pedigree” for that drug. To fulfil the epedigree requirements, extensions will need to be made to the data stored by the MST platform described above for each item to be tracked. This can be done by extending the MST platform or linking it to an existing ePedigree solution.

In order to support document-based pedigree, the platform would have to be able to handle certificates and digital signatures and XML data schemas, as well as industrial scale data storage. Industry standard databases such as MySQL and Oracle or other alternate formats may be used. Due to the wide range of document based pedigree standards in place, non-XML formats will be supported. The EPCglobal XML schema allows other types of documents (scanned images, PDF files, etc) to be attached in a MIME format. Current standards are open as to how ePedigrees are transmitted between trading partners. The MST platform described herein could be linked to an existing ePedigree solution.

The system of the invention offers numerous advantages, including: product authentication by the detection of an irregular history, for example cannot be in two places at once or cannot skip stages etc; history authentication if product is known to be genuine, which could highlight forged documentation or wrong service life for safe fitment to aircraft; history tracking of counterfeits to collect prosecution evidence; prediction of counterfeit events to aid proactive investigations; and providing senior corporate decision makers with trend data for supporting their strategies.

A skilled person will appreciate that variations of the disclosed arrangements are possible without departing from the invention. For example, whilst the invention has been described with reference to the capture of BPF events at BPF readers, in theory other kinds of events could be captured. For example, if a customs officer was alerted to some other situational factor that caused some suspicion that a shipment was anomalous. For this reason, events include the option of modelling non-scanning related information. Verifiable events could be defined as a super class of events, which have been verified as trusted by the trust management system. Accordingly the above description of the specific embodiment is made by way of example only and not for the purposes of limitation. It will be clear to the skilled person that minor modifications may be made without significant changes to the operation described.

1. A method of detecting unauthorised events occurring in a product supply chain, the method comprising:
receiving data associated with an item at a plurality of points in a supply chain;
generating a respective event record for the data received, and
comparing said generated event records with at least one modelled supply chain that has one or more expected states to detect generated event records that not match the expected states of the supply chain model.

2. A method as claimed in claim 1 comprising reading a machine readable tag or label physically associated with the product, thereby to generate the data associated with the item.

3. A method as claimed in claim 1 comprising processing generated event records relating to a single item in the supply chain so as to compile a representative life history of that item.

4. A method as claimed in claim 1 comprising applying at least one pattern matching method to match generated event records against one or more supply chain models.

5. A method as claimed in claim 4, wherein the at least one the pattern matching method comprises Markov modelling of event probabilities.

6. A method as claimed claim 1 comprising using the generated data to predict future anomalous events.

7. A method as claimed in claim 1 comprising monitoring movement of products through a given one of the supply chains, so that multiple passes of the supply chain are made by multiple products and using the event records generated to detect or predict one or more anomalous patterns.

8. A method as claimed in as claimed in claim 1 wherein the supply chain is at least one of: a drug and/or pharmaceutical product supply chain; a drugs dispensing supply chain; a spare parts supply chain, for example airline or automotive parts.

9. A product management system for use with data capture means for capturing data associated with items in a supply chain, the product management system comprising:
means for generating event records from data captured by the data capture means, each event record corresponding to data captured from an item at a point in a supply chain; and
processor means for processing each generated event record to compare said generated event records with at least one supply chain model, so as to detect any generated event records that do not match with said model supply chain.

10. A system as claimed in claim 9 comprising means for performing a predetermined action when the processor detects that one or more event records do not match said supply chain model.

11. A system as claimed in claim 9 comprising database means for storing the or each said supply chain model.

12. A system as claimed in claim 9, wherein the processor means are operable to map the generated event records to at least one said supply chain model.

13. A system as claimed in claim 12, wherein the mapping means comprises Markov modelling means.

14. A system as claimed in claim 9, wherein the processor means includes heuristic processing means.

15. A system as claimed in claim 9, wherein the processor means are operable to synthesize data from the generated event records.

16. A system as claimed in claim 9, wherein the processor means are operable to continually monitor the generated event records so as to detect automatically anomalies that represent potential threats.

17. A system as claimed in claim 9, wherein the processor means are operable to employ at least one of forward chaining rules and case based reasoning approaches.

18. A system as claimed in claim 9, wherein the product management system is configured for communication with the data capture means via a computer network.

19. A system as claimed in claim 9 configured to generate a predetermined response when an anomaly is detected by the processor means.

20. A method of detecting unauthorised events in a product supply chain, the method comprising:
monitoring movement of products through a supply chain or a part thereof using data captured from the products;
generating a respective event record for the data captured for each pass of the supply chain, and
using the event records generated to detect or predict one or more anomalous events.

21. A method as claimed in claim 20 comprising monitoring the movement of goods over a period in which multiple passes of the supply chain are made.

22. A method as claimed in claim 20 comprising using the event records to detect sequences or repeating patterns of events and using these to predict one or more future events.

23. A method as claimed in claim 20 comprising using a supply chain model together with the generated event records to detect or predict anomalous events.

24. A system for detecting unauthorised events occurring in a product supply chain, the system being configured to:
monitor movement of products through a supply chain using data captured from the products at a plurality of points in the chain over a period such that multiple passes are made by multiple products;
generate a respective event record for the data captured for each pass of the supply chain and
use the event records generated to detect or predict one or more anomalous patterns or future events.

25. A system as claimed in claim 24 adapted to monitor the movement of goods over a period in which multiple passes of the supply chain are made.

26. A system as claimed in claim 24 that is adapted to detect sequences or repeating patterns of events using the event records and use these to predict one or more anomalous patterns or future events.

27. A system as claimed in claim 24 that is adapted to use a supply chain model together with the generated event records to detect or predict anomalous events.

28. An apparatus comprising data capture means for capturing data associated with products in a supply chain and a product management system according to claim 9.

29. (canceled)
